(19) United States
(12) Patent Application Publication
(10) Pub. No.: US 2018/0343247 A1
(43) Pub. Date: Nov. 29, 2018

(54) METHOD, USER TERMINAL AND AUTHENTICATION SERVICE SERVER FOR AUTHENTICATION

(71) Applicant: SAMSUNG SDS CO., LTD., Seoul (KR)

(72) Inventor: Dong-Ho KIM, Seoul (KR)

(73) Assignee: SAMSUNG SDS CO., LTD., Seoul (KR)

(21) Appl. No.: 15/989,364

(22) Filed: May 25, 2018

(30) Foreign Application Priority Data
May 26, 2017 (KR) 10-2017-0065577

(51) Int. Cl. H04L 29/06; H04L 9/32; H04L 9/08; G06K 9/00

(52) U.S. Cl. CPC H04L 63/0861; H04L 9/3213; G06K 9/00926; H04L 63/12; H04L 9/0866

(57) ABSTRACT

A method, user terminal, and authentication service server for authentication are provided. According to the embodiments of the present disclosure, the non-face-to-face authentication process and the registration process for biometric information-based authentication are performed together, so that the amount of transaction occurring in the registration process for non-face-to-face authentication and biometric information-based authentication can be minimized.

### CROSS-REFERENCE TO RELATED APPLICATION(S)

This application claims the benefit under 35 USC § 119(a) of Korean Patent Application No. 10-2017-0065577, filed on May 26, 2017, in the Korean Intellectual Property Office, the entire disclosure of which is incorporated herein by reference for all purposes.

### BACKGROUND

### 1. Field

The following description relates to a non-face-to-face authentication technology.

### 2. Description of Related Art

Non-face-to-face authentication is a technique of authenticating a user using a user's image, fingerprint and the like without face-to-face communication. Fast identity online (FIDO) authentication is a technique of authenticating a user using user's biometric information, such as fingerprints, iris, face information, and the like. These authentication techniques are advantageous in that they are easier to use compared with existing authentication methods, and the need for them is increasing.

In addition, authentication technologies that perform non-face-to-face authentication and FIDO authentication together have been recently developed. Generally, in these authentication technologies, the non-face-to-face authentication and the FIDO authentication are separately performed in individual procedures.

However, according to such authentication technologies, since the non-face-to-face authentication and the FIDO authentication are separately performed, transaction between a user terminal and a server is increased, which makes it difficult to provide a service requiring quick authentication.

In addition, when the non-face-to-face authentication and the FIDO authentication are separately performed, a security issue may arise because another user may perform the FIDO authentication after the non-face-to-face authentication.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present disclosure are directed to providing a method, user terminal and authentication service server for performing authentication.

In one general aspect, there is provided a user terminal including: a token generator configured to generate a token by using identification information; an initialization processor configured to transmit a registration initialization message including the identification information to a non-face-to-face authentication service server; a message receiver configured to: receive an authentication target data request message for requesting authentication target data for non-face-to-face authentication and receive a registration request message for requesting registration information to be registered in a biometric authentication server that performs biometric information-based authentication from the non-face-to-face authentication service server; a data input device configured to receive the authentication target data that is input by a user; an encryptor configured to encrypt the authentication target data using the token; a registration information generator configured to generate the registration information by performing authentication of the user; and a registration processor configured to : transmit the encrypted authentication target data and a registration response message including the registration information to the non-face-to-face authentication service server; and receive a result of the non-face-to-face authentication and a registration result of the registration information from the non-face-to-face authentication service server.

The registration request message and the registration response message may each include a verification value generated at the biometric authentication server.

The user terminal may further include a template generator configured to generate an authentication template by extracting a feature of the authentication target data and a storage configured to store at least one from among the token and the authentication template.

The registration information generator may be further configured to generate a pair of public key and private key by performing authentication of the user using biometric information of the user and the registration information may include the public key.

The identification information may comprise user identification information and user terminal identification information.

The token may comprise a hash value for each of the user identification information and the user terminal identification information.

In another general aspect, there is provided a anon-face-to-face authentication service server including: an initialization processor configured to: receive a registration initialization message including identification information from a user terminal; and transmit the registration initialization message to a biometric authentication server; a token generator configured to generate a token using the identification information; a message processor configured to: receive a registration request message for requesting registration information from the biometric authentication server; and transmit the registration request message and an authentication target data request message for requesting authentication target data for non-face-to-face authentication to the user terminal; a data receiver configured to receive the authentication target data and a registration response message including the registration information from the user terminal; a non-face-to-face authentication processor configured to : decrypt the received authentication target data using the token; provide the decrypted authentication target data to an authentication administrator that performs non-face-to-face authentication; and receive a result of the non-face-to-face authentication from the authentication administrator; a registration processor configured to transmit the registration response message to the biometric authentication server when the non-face-to-face authentication is successfully performed, and receive a registration result of the registration information from the biometric authentication server; and a result provider configured to transmit the non-face-to-face authentication result and the registration result of the registration information to the user terminal.

The registration request message and the registration response message may each include a verification value generated at the biometric authentication server.

The identification information may comprise user identification information and user terminal identification information of the user terminal.

The token may comprise a hash value for each of the user identification information and the user terminal identification information.

The non-face-to-face authentication service server may further include a storage configured to store at least one from among the token and the authentication target data.

In still another general aspect, there is provided a method of authentication performed by a user terminal, the method including: generating a token by using identification information; transmitting a registration initialization message including the identification information to a non-face-to-face authentication service server; receiving an authentication target data request message for requesting authentication target data for non-face-to-face authentication; receiving a registration request message for requesting registration information to be registered in a biometric authentication server that performs biometric information-based authentication from the non-face-to-face authentication service server; receiving the authentication target data that is input by a user; encrypting the authentication target data using the token; generating the registration information by performing authentication of the user; transmitting the encrypted authentication target data and a registration response message including the registration information to the non-face-to-face authentication service server; and receiving a result of the non-face-to-face authentication and a registration result of the registration information from the non-face-to-face authentication service server.

The registration request message and the registration response message may each include a verification value generated at the biometric authentication server.

The method may further include: generating an authentication template by extracting a feature from the authentication target data; and storing at least one from among the token and the authentication template.

The generating of the registration information may comprise generating a pair of public key and private key by performing authentication of the user using biometric information of the user and the registration information may include the public key.

The identification information may comprise user identification information and user terminal identification information.

The token may include a hash value for each of the user identification information and the user terminal identification information.

In yet another general aspect, there is provided a method of authentication performed by a non-face-to-face authentication service server, the method including: receiving a registration initialization message including identification information from a user terminal; generating a token using the identification information; transmitting the registration initialization message to a biometric authentication server; receiving a registration request message for requesting registration information from the biometric authentication server; transmitting the registration request message and an authentication target data request message for requesting authentication target data for non-face-to-face authentication to the user terminal; receiving the authentication target data and a registration response message including the registration information from the user terminal; decrypting the received authentication target data using the token and providing the decrypted authentication target data to an authentication administrator that performs non-face-to-face authentication; receiving a result of the non-face-to-face authentication from the authentication administrator; transmitting the registration response message to the biometric authentication server when the non-face-to-face authentication is successfully performed; receiving a registration result of the registration information from the biometric authentication server; and transmitting the non-face-to-face authentication result and the registration result of the registration information to the user terminal.

The registration request message and the registration response message may each include a verification value generated at the biometric authentication server.

The identification information may comprise user identification information and user terminal identification information of the user terminal.

The token may comprise a hash value for each of the user identification information and the user terminal identification information.

The method may further include storing at least one from among the token and the authentication target data.

Other features and aspects will be apparent from the following detailed description, the drawings, and the claims.

### BRIEF DESCRIPTION OF THE DRAWINGS

FIG. 1 is a diagram illustrating a configuration of an authentication system according to one embodiment of the present disclosure.

FIG. 2 is a diagram illustrating a configuration of a user terminal according to one embodiment of the present disclosure.

FIG. 3 is a diagram illustrating a configuration of a user terminal according to an additional embodiment of the present disclosure.

FIG. 4 is a diagram illustrating a configuration of a non-face-to-face authentication service server according to one embodiment of the present disclosure.

FIG. 5 is a flowchart illustrating a registration process according to one embodiment of the present disclosure.

FIG. 6 is a flowchart illustrating a process of registering an additional terminal according one embodiment of the present disclosure.

FIG. 7 is a flowchart illustrating an authentication process according to one embodiment of the present disclosure.

FIG. 8 is a flowchart illustrating a method of authentication performed by a user terminal 100 according to one embodiment of the present disclosure.

FIG. 9 is a flowchart illustrating a method of authentication performed by a non-face-to-face authentication service server according to one embodiment of the present disclosure.

FIG. 10 is a block diagram for describing a computing environment including a computing device suitable for use in exemplary embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

Descriptions of well-known functions and constructions may be omitted for increased clarity and conciseness. Also, terms described in below are selected by considering functions in the embodiment and meanings may vary depending on, for example, a user or operator's intentions or customs. Therefore, definitions of the terms should be made on the basis of the overall context. The terminology used in the detailed description is provided only to describe embodiments of the present disclosure and not for purposes of limitation. Unless the context clearly indicates otherwise, the singular forms include the plural forms. It should be understood that the terms “comprises” or “includes” specify some features, numbers, steps, operations, elements, and/or combinations thereof when used herein, but do not preclude the presence or possibility of one or more other features, numbers, steps, operations, elements, and/or combinations thereof in addition to the description.

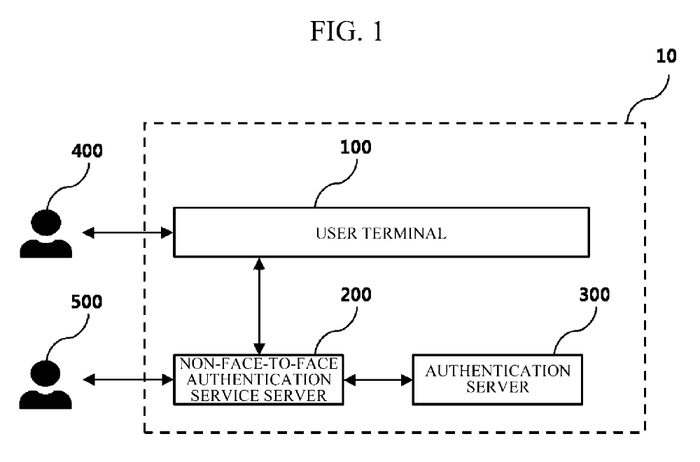

FIG. 1 is a diagram illustrating a configuration of an authentication system according to one embodiment of the present disclosure.

Referring to FIG. 1, the authentication system 10 according to one embodiment of the present disclosure includes a user terminal 100, a non-face-to-face authentication service server 200, and a biometric authentication server 300.

The user terminal 100 is a device used for receiving an authentication service from the non-face-to-face authentication service server 200 and the biometric authentication server 300 and may be, for example, a desktop computer, a notebook computer, a tablet computer, a smartphone, a personal digital assistant (PDA), a wearable device, such as a smart watch, or the like.

Specifically, the user terminal 100 may be provided with a non-face-to-face authentication service by transmitting data desired to be authenticated (hereinafter, referred to as “authentication target data”), such as face information, voice information, fingerprint information, iris information, and the like of a user 400, to the non-face-to-face authentication service server 200. The user terminal 100 may include an input device, such as a camera, a microphone, a fingerprint recognition device, or the like, in order to acquire the authentication target data from the user 400.

In addition, the user terminal 100 may be provided with an authentication service of the biometric authentication server 300 that performs biometric information-based authentication through the non-face-to-face authentication service server 200.

The non-face-to-face authentication service server 200 may provide a non-face-to-face authentication service for the user 400 and relay an authentication process performed between the user terminal 100 and the biometric authentication server 300.

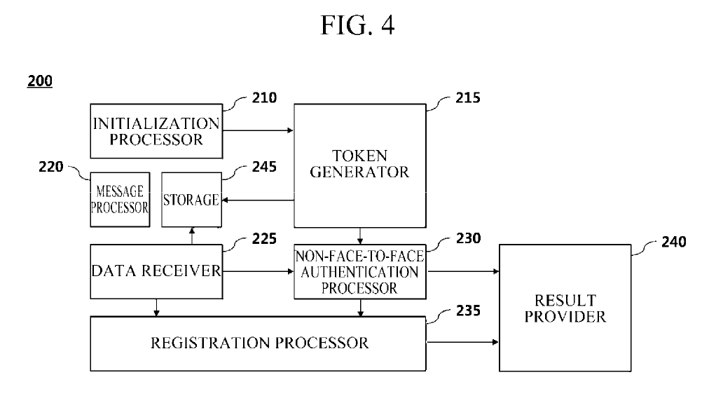

Specifically, the non-face-to-face authentication service server 200 may provide the authentication target data received from the user terminal 100 to an authentication administrator 500 and receive a non-face-to-face authentication result from the authentication administrator 500. In this case, the authentication administrator 500 may compare reference data stored in advance with the authentication target data, determine whether they are the same or similar to each other, and transmit a non-face-to-face authentication result to the non-face-to-face authentication service server 200. In addition, the non-face-to-face authentication service server 200 may relay messages transmitted and received between the user terminal 100 and the biometric authentication server 300 for biometric information-based authentication. A configuration of the non-face-to-face authentication server 200 will be described in detail with reference to FIG. 4.

The biometric authentication server 300 is a server to perform biometric information-based authentication and may perform authentication using registration information generated in the user terminal 100. In embodiments of the present disclosure, the biometric authentication server 300 may be a server for performing, for example, fast identity online (FIDO) authentication. Meanwhile, in embodiments of the present disclosure, messages transmitted and received to perform FIDO authentication (e.g., registration initialization message, registration request message, registration response message, authentication initialization message, authentication request message, and authentication response message) may be messages in accordance with universal authentication framework (UAF) protocol of the FIDO authentication technique.

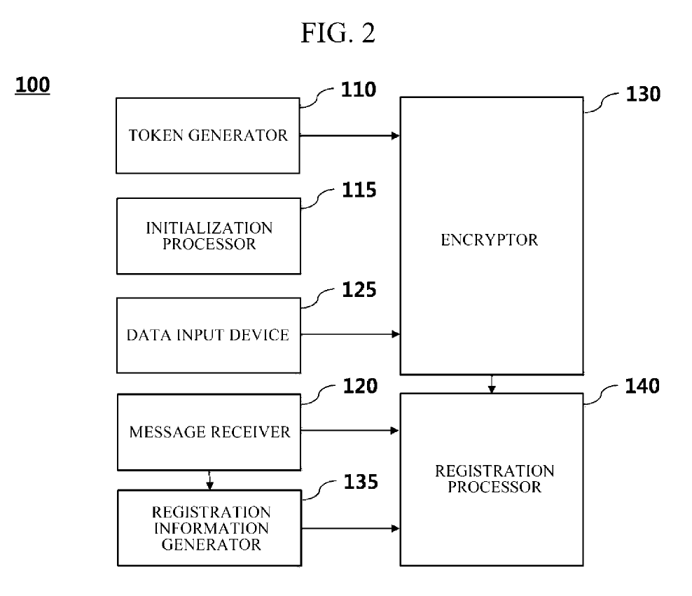

FIG. 2 is a diagram illustrating a configuration of a user terminal 100 according to one embodiment of the present disclosure.

Referring to FIG. 2, the user terminal 100 according to one embodiment of the present disclosure includes a token generator 110, an initialization processor 115, a message receiver 120, a data input device 125, an encryptor 130, a registration information generator 135, and a registration processor 140.

The token generator 100 generates a token using identification information. In this case, the identification information may include, for example, user identification information (e.g., user ID) and user terminal identification information (e.g., terminal ID).

The token generated by the token generator 100 may include, for example, a hash value for each of the user identification information and the user terminal identification information.

Specifically, the token generator 110 may determine whether a token corresponding to the identification information is present in the user terminal 100, and when there is no corresponding token, the token generator 110 may generate a token by hashing the identification information.

The initialization processor 115 transmits a registration initialization message including the identification information to the non-face-to-face authentication service server 200. In this case, the identification information may include the identification information used to generate the token.

The message receiver 120 receives an authentication target data request message and a registration request message from the non-face-to-face authentication service server 200. In this case, the authentication target data request message may be a message for requesting authentication target data for non-face-to-face authentication to be performed at the non-face-to-face authentication service server 200. In addition, the registration request message may be a message for requesting registration data to be registered in the biometric authentication server 300.

Specifically, the registration request message may include, for example, at least one of policy information regarding an authentication device (e.g., a fingerprint recognition device) to be used when the registration information generator 135 performs authentication of the user and a verification value generated at the biometric authentication server 300.

The data input device 125 receives the authentication target data input from the user 400. In this case, the authentication target data is data to be provided to the authentication administrator 500 through the non-face-to-face authentication service server 200 and may include unique biometric information of the user 400. For example, the authentication target data may be data including face information, voice information, fingerprint information, iris information, vein information and the like of the user 400.

For example, the data input device 125 may receive the authentication target data by capturing an image of a face of the user 400, recording the voice of the user 400, or scanning a fingerprint of the user 400.

The encryptor 130 encrypts the authentication target data input through the data input device 125 using the token generated by the token generator 100.

In this case, according to one embodiment of the present disclosure, the encryptor 130 may embed watermark into the authentication target data input through the data input device 125 and then encrypt the authentication target data using the token.

The registration information generator 135 performs authentication of the user 400 in response to the registration request message received through the message receiver 120 and generates registration information when the authentication is successfully performed.

At this time, the registration information generator 135 may select an authentication device to be used in authentication of biometric information among one or more authentication devices by referring to, for example, policy information included in the registration request message. However, transmission of the policy information and selection of the authentication device according to the policy information may be omitted as necessary and the authentication device to be used in authentication of biometric information may be set in advance.

Specifically, the registration information generator 135 may perform authentication of the user 400 using the biometric information of the user 400, such as fingerprint information, generate a pair of public key and private key, and generate registration information including the generated public key.

In addition, the registration processor 140 transmits a registration response message including the registration information generated by the registration information generator 135 and the authentication target data encrypted by the encryptor 130 to the non-face-to-face authentication service server 200. In this case, the registration response message may include the same verification value as that included in the registration request message received by the message receiver 120.

Moreover, the registration processor 140 may receive the non-face-to-face authentication result and a registration result of the registration information from the non-face-to-face authentication service server. In this case, the registration result of the registration information may be generated by the biometric authentication server 300 and transmitted through the authentication service server 200.

In this case, the non-face-to-face authentication result and the registration result of the registration information may be output to the user 400 through an output device (not shown) provided separately.

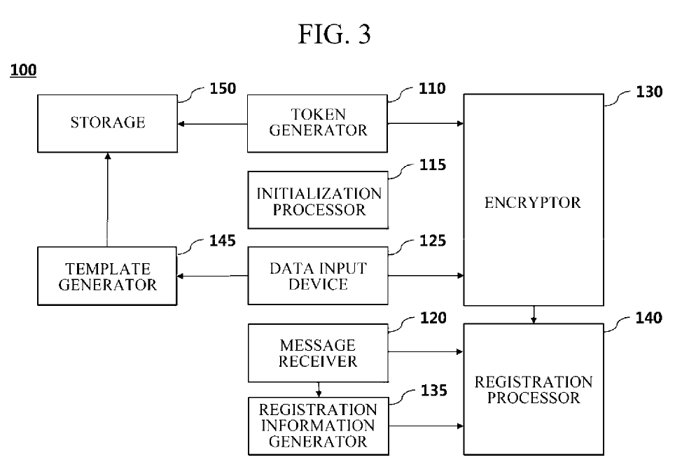

FIG. 3 is a diagram illustrating a configuration of a user terminal 100 according to an additional embodiment of the present disclosure.

Referring to FIG. 3, the user terminal 100 according to an additional embodiment of the present disclosure further includes a template generator 145 and a storage 150.

The template generator 145 may extract a feature of authentication target data input through a data input device 125 and generate an authentication template.

Specifically, the template generator 145 may extract features of the authentication target data using a method set in advance according to the type of authentication target data. For example, when the authentication target data is data including face information of the user 400, the template generator 145 may generate an authentication template by extracting features, such as a distance between the eyes of the user 400, the length and width of the nose, the length of the jaw line, and the like.

The storage 150 may store at least one of a token generated by a token generator 110 and the authentication template generated by the template generator 145.

In this case, the storage 150 may store at least one of the token and the authentication template using, for example, a hardware security module (e.g., trusted execution environment (TEE), SE (eSE, USIM, MSD), or the like), a software security module (e.g., white box cryptography (WBC) or the like), and the like.

FIG. 4 is a diagram illustrating a configuration of a non-face-to-face authentication service server 200 according to one embodiment of the present disclosure.

Referring to FIG. 4, the non-face-to-face authentication service server 200 according to one embodiment of the present disclosure includes an initialization processor 210, a token generator 215, a message processor 220, a data receiver 225, a non-face-to-face authentication processor 230, a registration processor 235, a result provider 240, and a storage 245.

The initialization processor 210 receives a registration initialization message including identification information from a user terminal 100 and forwards it to a biometric authentication server 300. In this case, the identification information is information used for identifying a user and a user terminal and may include, for example, user identification information (e.g., user ID) and user terminal identification information (e.g., terminal ID).

The token generator 215 generates a token using the identification information received by the initialization processor 210. In this case, the token may include a hash value for each of the user identification information and the user terminal identification information.

The message processor 220 receives a registration request message for requesting registration information from the biometric authentication server 300 and transmits the registration request message and an authentication target data request message for requesting authentication target data for non-face-to-face authentication to the user terminal 100.

The registration request message may include, for example, at least one of policy information regarding an authentication device (e.g., a fingerprint recognition device) to be used when the user terminal 100 performs authentication of the user and a verification value generated at the biometric authentication server 300.

The data receiver 225 receives the authentication target data and a registration response message including the registration information from the user terminal 100. Here, the authentication target data may be data including unique biometric information of the user 400. For example, the authentication target data may be data including face information, voice information, fingerprint information, iris information, vein information and the like of the user 400.

Meanwhile, the authentication target data received from the user terminal 100 may be received in an encrypted state using the token which is generated using the user's identification information.

The non-face-to-face authentication processor 230 may provide the received authentication target data to the authentication administrator 500 that performs non-face-to-face authentication and then receive a non-face-to-face authentication result from the authentication administrator 500. In this case, when the authentication target data received from the user terminal 100 is data encrypted using a token generated by the user terminal 100, the non-face-to-face authentication processor 230 may decrypt the authentication target data using a token generated by the token generator 215 and then provide the decrypted data to the authentication administrator 500.

The authentication administrator 500 may compare pre-stored reference data with the authentication target data provided from the non-face-to-face authentication service server 200 to determine whether they are the same or similar to each other, and provide a determination result to the non-face-to-face authentication service server 200. In this case, the reference data may be data including, for example, user's unique biometric information, such as face information, voice information, fingerprint information, iris information, vein information, and the like of the user.

When the non-face-to-face authentication is successfully performed, the registration processor 235 transmits a registration response message received from the user terminal 100 and then receives a registration result of the registration information from the biometric authentication server 300.

The result provider 240 may transmit the non-face-to-face authentication result and a registration result of the registration information to the user terminal 100.

The storage 245 may store at least one of the toke generated by the token generator 215 and the authentication target data received through the data receiver 225.

In this case, the storage 245 may store at least one of the token and the authentication template using, for example, a hardware security module (e.g., TEE, SE (eSE, USIM, MSD), or the like), a software security module (e.g., WBC or the like), and the like.

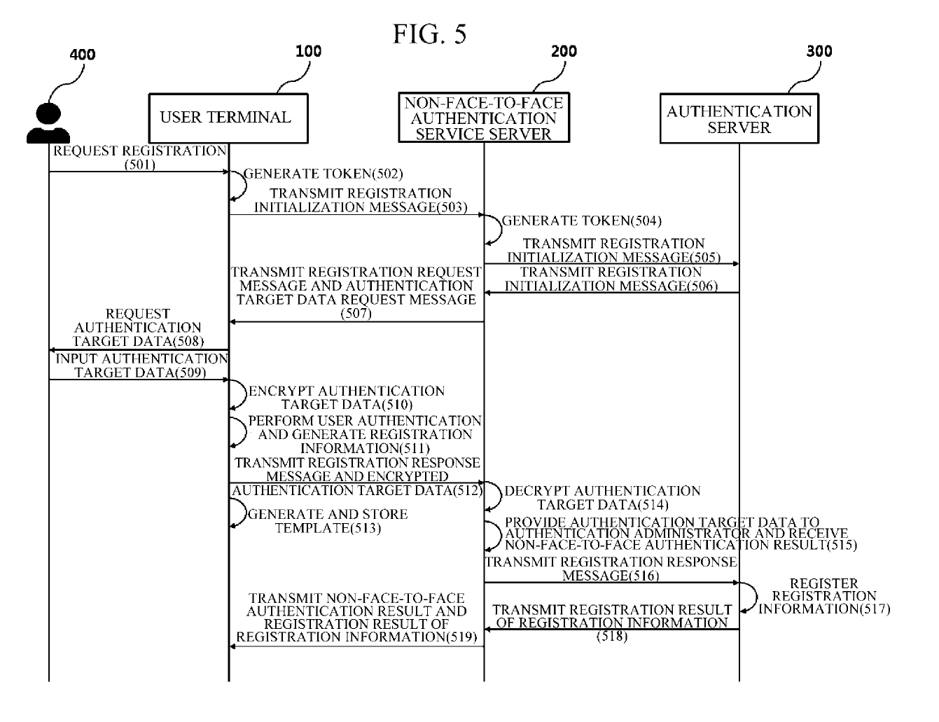

FIG. 5 is a flowchart illustrating a registration process according to one embodiment of the present disclosure. In the flowcharts described herein, one process is illustrated as being divided into a plurality of operations. However, it should be noted that at least some of the operations may be performed in different order or may be combined into fewer operations or further divided into more operations. In addition, some of the operations may be omitted, or one or more extra operations, which are not illustrated, may be added to the flowchart and be performed.

First, a user terminal 100 receives a request for registering a user and a terminal from a user 400 in operation 501. In this case, the user terminal 100 may also receive user's identification information from the user 400.

Then, the user terminal 100 generates a token using the user identification information and user terminal identification information in operation 502.

The user terminal 100 transmits a registration initialization message including the identification information to a non-face-to-face authentication service server 200 in operation 503.

Then, the non-face-to-face authentication service server 200 generates a token using the identification information in operation 504.

The non-face-to-face authentication service server 200, then, transmits the registration initialization message to a biometric authentication server 300 in operation 505.

Then, the non-face-to-face authentication service server 200 receives a registration request message from the biometric authentication server 300 in operation 506. At this time, the registration request message may include a verification value generated at the biometric authentication server 300.

Then, the non-face-to-face authentication service server 200 transmits the registration request message and an authentication target data request message to the user terminal 100 in operation 507.

Then, the user terminal 100 requests the user terminal 400 for authentication target data and receives the authentication target data in operations 508 and 509.

Then, the user terminal 100 encrypts the authentication target data using the token in operation 510.

Then, the user terminal 100 performs authentication of the user 400 using biometric information and generates registration information to be registered in the biometric authentication server 300 in operation 511.

Thereafter, the user terminal 100 transmits the encrypted authentication target data and a registration response message including the registration information to the non-face-to-face authentication service server 200 in operation 512. In this case, the registration response message may include the same verification value as that included in the registration request message.

Then, the user terminal 100 generates an authentication template by extracting a feature of the authentication target data and stores the authentication template in operation 513.

Then, the non-face-to-face authentication service server 200 decrypts the authentication target data using a token in operation 514.

Then, the non-face-to-face authentication service server 200 provides the authentication target data to an authentication administrator 500 and receives a non-face-to-face authentication result from the authentication administrator 500 in operation 515.

Then, when the non-face-to-face authentication is successfully performed, the non-face-to-face authentication service server 200 transmits a registration response message to the biometric authentication server 300 in operation 516. Accordingly, the biometric authentication server 300 registers the registration information included in the registration response message in operation 517. At this time, the biometric authentication server 300 may register the registration information by, for example, determining whether the verification value included in the registration response message is the same as the verification value included in the registration request message previously transmitted.

Then, the non-face-to-face authentication service server 200 receives a registration result of the registration information from the biometric authentication server 300 in operation 518.

Thereafter, the non-face-to-face authentication service server 200 transmits the non-face-to-face authentication result and a registration result of the registration information to the user terminal 100 in operation 519.

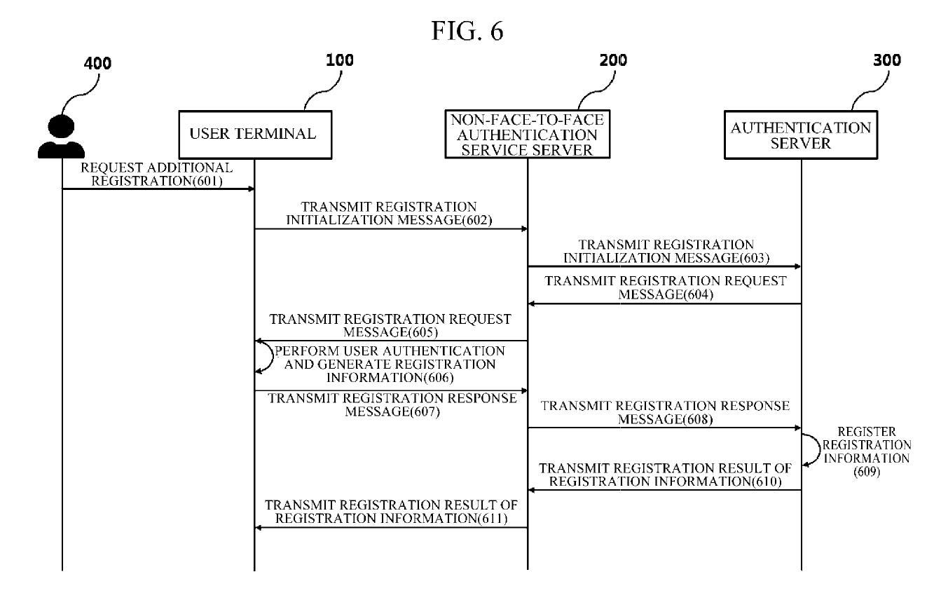

FIG. 6 is a flowchart illustrating a process of registering an additional terminal according one embodiment of the present disclosure. Specifically, FIG. 6 is a flowchart illustrating a process performed when, after registration of a specific user and a terminal in a biometric authentication server 300 is completed, the same user wants to register another terminal.

First, a user terminal 100 receives a request for registration of additional terminal from a user 400 in operation 601.

Then, the user terminal 100 transmits a registration initialization message including identification information to a non-face-to-face authentication service server 200 in operation 602.

Then, the non-face-to-face authentication service server 200 transmits the registration initialization message to a biometric authentication server 300 in operation 603.

Then, the non-face-to-face authentication service server 200 receives a registration request message from the biometric authentication server 300 in operation 604. In this case, the registration request message may include a verification value generated at the biometric authentication server 300.

Then, the non-face-to-face authentication service server 200 transmits the registration request message to the user terminal 100 in operation 605.

Then, the user terminal 100 performs authentication of the user 400 using biometric information and generates registration information to be registered in the biometric authentication server 300 in operation 606.

The user terminal 100 transmits a registration response message including the registration information to the non-face-to-face authentication service server 200 in operation 607. In this case, the registration response message may include the same verification value as that included in the registration request message.

Thereafter, the non-face-to-face authentication service server transmits the registration response message including the registration information to the biometric authentication server 300 in operation 608. Accordingly, the biometric authentication server 300 registers the registration information included in the registration response message in operation 609. At this time, the biometric authentication server 300 may register the registration information by, for example, determining whether the verification information included in the registration response message is the same as the verification value included in the registration request message transmitted previously.

Then, the non-face-to-face authentication service server 200 receives a registration result of the registration information from the biometric authentication server 300 in operation 610.

Then, the non-face-to-face authentication service server 200 transmits a registration result of the registration information to the user terminal 100 in operation 611.

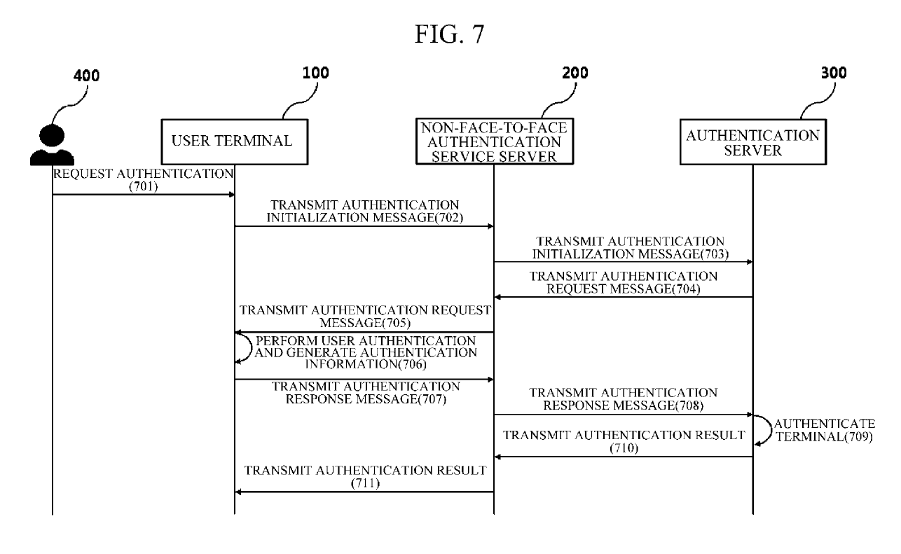

FIG. 7 is a flowchart illustrating an authentication process according to one embodiment of the present disclosure. Specifically, FIG. 7 is a flowchart illustrating a process of authenticating a user and a terminal after completion of registration of the user and the terminal in a biometric authentication server 300.

First, a user terminal 100 receives a request for authentication from a user 400 in operation 701.

Then, the user terminal 100 transmits an authentication initialization message to a non-face-to-face authentication service server 200 in operation 702.

Then, the non-face-to-face authentication service server 200 transmits the authentication initialization message to the biometric authentication server 300 in operation 703.

Then, the non-face-to-face authentication service server 200 receives an authentication request message from the biometric authentication server 300 in operation 704. In this case, the authentication request message may include a verification value generated at the biometric authentication server 300.

Then, the non-face-to-face authentication service server 200 transmits the authentication request message to the user terminal 100 in operation 705.

Then, the user terminal 100 performs authentication of the user 400 using, for example, biometric information and generates authentication information to be provided to the biometric authentication server 300 in operation 706.

Then, the user terminal 100 transmits an authentication response message including the authentication information to the non-face-to-face authentication service server 200 in operation 707. In this case, the authentication response message may include the same verification value as that included in the authentication request message.

Thereafter, the non-face-to-face authentication service server 200 transmits the authentication response message to the biometric authentication server 300 in operation 708. Accordingly, the biometric authentication server 300 authenticates a terminal in operation 709. At this time, the biometric authentication server 300 may authenticate the terminal by, for example, determining whether the verification value included in the authentication response message is the same as the verification value included in the authentication request message.

Then, the non-face-to-face authentication service server 200 receives the authentication result from the biometric authentication server 300 in operation 710.

Then, the non-face-to-face authentication service server 200 transmits the authentication result to the user terminal 100 in operation 711.

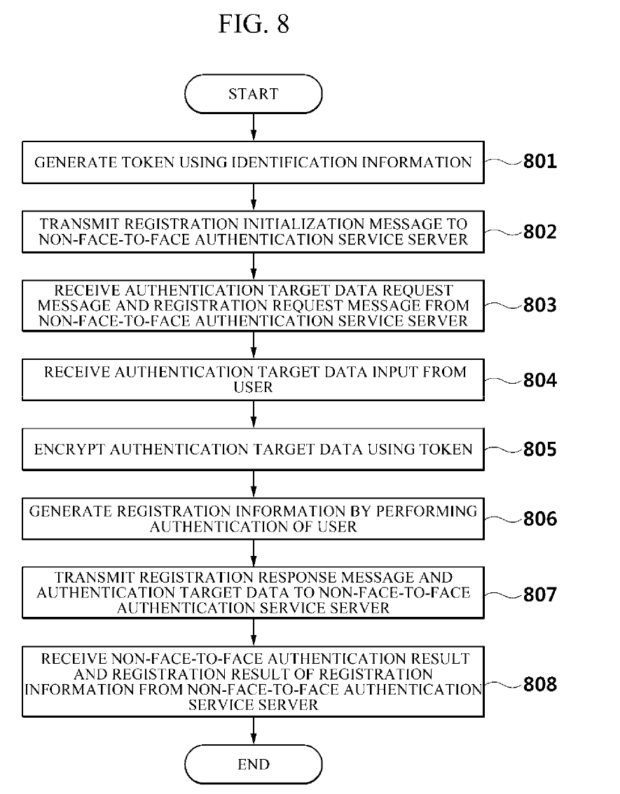

FIG. 8 is a flowchart illustrating a method of authentication performed by a user terminal 100 according to one embodiment of the present disclosure.

Referring to FIG. 8, the user terminal 100 generates a token using identification information in operation 801. In this case, the identification information may include user identification information and user terminal identification information. In addition, the token may include a hash value for each of the user identification information and the user terminal information.

The user terminal 100 transmits a registration initialization message including the identification information to the non-face-to-face authentication service server 200 in operation 802.

The user terminal 100 receives an authentication target data request message for requesting authentication target data for non-face-to-face authentication and a registration request message for requesting registration information to be registered in a biometric authentication server 300 that performs biometric information-based authentication from the non-face-to-face authentication service server 200 in operation 803. In this case, the registration request message may include a verification value generated at the biometric authentication server 300.

The user terminal receives authentication target data from the user 400 in operation 804.

The user terminal 100 encrypts the authentication target data using the token in operation 805.

The user terminal 100 generates registration information by performing authentication of the user 400 in operation 806. In this case, the user terminal 100 may generate a pair of public key and private key by performing authentication of the user 400 using biometric information of the user 400 and the registration information may include a public key.

The user terminal 100 transmits encrypted authentication target data and a registration response message including the registration information to the non-face-to-face authentication service server 200 in operation 807. In this case, the registration response message may include the same verification value as that included in the registration request message.

The user terminal 100 may receive a non-face-to-face authentication result and an authentication result of the authentication information from the non-face-to-face authentication service server 200 in operation 808.

In addition, the user terminal 100 may generate an authentication template by extracting a feature of the authentication target data.

Moreover, the user terminal 100 may store at least one of the token and the authentication template.

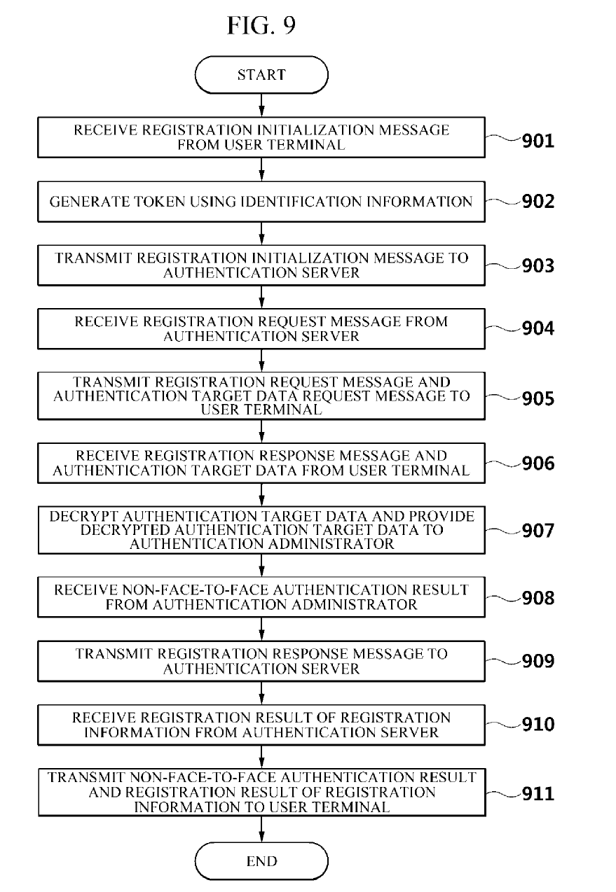

FIG. 9 is a flowchart illustrating a method of authentication performed by a non-face-to-face authentication service server 200 according to one embodiment of the present disclosure.

Referring to FIG. 9, the non-face-to-face authentication service server 200 receives a registration initialization message including identification information from a user terminal 100 in operation 901. In this case, the identification information may include user identification information and user terminal identification information of the user terminal 100.

The non-face-to-face authentication service server 200 generates a token using the identification information in operation 902. In this case, the token may include a hash value for each of the user identification information and the user terminal identification information.

The non-face-to-face authentication service server 200 transmits a registration initialization message to a biometric authentication server 300 in operation 903.

The non-face-to-face authentication service server 200 receives a registration request message for requesting registration information from the biometric authentication server 300 in operation 904. In this case, the registration request message may include a verification value generated at the biometric authentication server 300.

The non-face-to-face authentication service server 200 transmits the registration request message and an authentication target data request message for requesting authentication target data for non-face-to-face authentication to the user terminal 100 in operation 905.

The non-face-to-face authentication service server 200 receives authentication target data and a registration response message including the registration information from the user terminal 100 in operation 906. In this case, the registration response message may include a verification value generated at the biometric authentication server 300.

The non-face-to-face authentication service server 200 decrypts the received authentication target data using the token and transmits the decrypted authentication target data to an authentication administrator 500 that performs non-face-to-face authentication in operation 907.

The non-face-to-face authentication service server 200 receives a non-face-to-face authentication result from the authentication administrator 500 in operation 908.

When the non-face-to-face authentication is successfully performed, the non-face-to-face authentication service server 200 transmits a registration response message to the biometric authentication server 300 in operation 909.

The non-face-to-face authentication service server 200 receives a registration result of the registration information from the biometric authentication server 300 in operation 910.

The non-face-to-face authentication service server 200 transmits the non-face-to-face authentication result and the registration result of the registration information to the user terminal 100 in operation 911.

In addition, the non-face-to-face authentication service server 200 may store at least one of the token and the authentication target data.

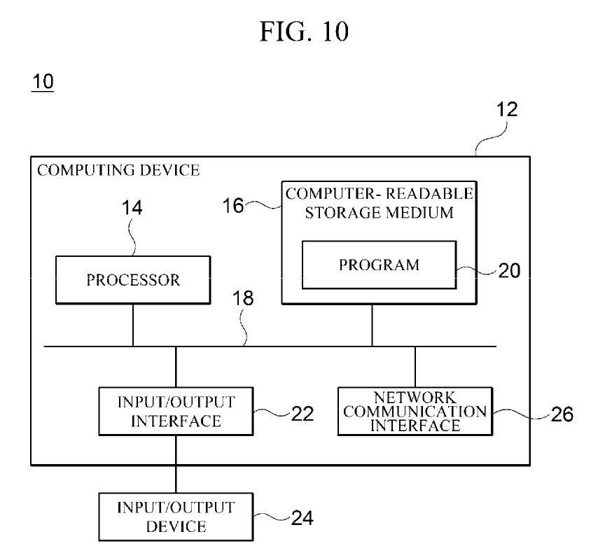

FIG. 10 is a block diagram for describing a computing environment including a computing device suitable for use in exemplary embodiments. In the illustrated embodiment, each of the components may have functions and capabilities different from those described hereinafter and additional components may be included in addition to the components described herein.

The illustrated computing environment 10 includes a computing device 12. In one embodiment, the computing device 12 may be an authentication system 10 or one or more components included in the authentication system 10.

The computing device 12 includes at least one processor 14, a computer-readable storage medium 16, and a communication bus 18. The processor 14 may cause the computing device 12 to operate according to the above-described exemplary embodiment. For example, the processor 14 may execute one or more programs stored in the computer-readable storage medium 16. The one or more programs may include one or more computer executable commands, and the computer executable commands may be configured to, when executed by the processor 14, cause the computing device 12 to perform operations according to the illustrative embodiment.

The computer readable storage medium 16 is configured to store computer executable commands and program codes, program data and/or information in other suitable forms. The programs stored in the computer readable storage medium 16 may include a set of commands executable by the processor 14. In one embodiment, the computer readable storage medium 16 may be a memory (volatile memory, such as random access memory (RAM), non-volatile memory, or a combination thereof) one or more magnetic disk storage devices, optical disk storage devices, flash memory devices, storage media in other forms capable of being accessed by the computing device 12 and storing desired information, or a combination thereof.

The communication bus 18 connects various other components of the computing device 12 including the processor 14 and the computer readable storage medium 16.

The computing device 12 may include one or more input/output interfaces 22 for one or more input/output devices 24 and one or more network communication interfaces 26. The input/output interface 22 and the network communication interface 26 are connected to the communication bus 18. The input/output device 24 may be connected to other components of the computing device 12 through the input/output interface 22. The illustrative input/output device 24 may be a pointing device (a mouse, a track pad, or the like), a keyboard, a touch input device (a touch pad, a touch screen, or the like), an input device, such as a voice or sound input device, various types of sensor devices, and/or a photographing device, and/or an output device, such as a display device, a printer, a speaker, and/or a network card. The illustrative input/output device 24 which is one component constituting the computing device 12 may be included inside the computing device 12 or may be configured as a separate device from the computing device 12 and connected to the computing device 12.

According to the embodiments of the present disclosure, the non-face-to-face authentication process and the registration process for biometric information-based authentication are performed together, so that the amount of transaction occurring in the registration process for non-face-to-face authentication and biometric information-based authentication can be minimized.

In addition, according to the embodiments of the present disclosure, the non-face-to-face authentication process and the registration process for biometric information-based authentication are performed together, so that security issues which may arise when the processes are separately performed may be prevented.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A user terminal comprising:
a token generator configured to generate a token by using identification information;
an initialization processor configured to transmit a registration initialization message including the identification information to a non-face-to-face authentication service server;
a message receiver configured to:
receive an authentication target data request message for requesting authentication target data for non-face-to-face authentication; and
receive a registration request message for requesting registration information to be registered in a biometric authentication server that performs biometric information-based authentication from the non-face-to-face authentication service server;
a data input device configured to receive the authentication target data that is input by a user;
an encryptor configured to encrypt the authentication target data using the token;
a registration information generator configured to generate the registration information by performing authentication of the user; and
a registration processor configured to:
transmit the encrypted authentication target data and a registration response message including the registration information to the non-face-to-face authentication service server; and
receive a result of the non-face-to-face authentication and a registration result of the registration information from the non-face-to-face authentication service server.

2. The user terminal of claim 1, wherein the registration request message and the registration response message each include a verification value generated at the biometric authentication server.

3. The user terminal of claim 1, further comprising:
a template generator configured to generate an authentication template by extracting a feature of the authentication target data; and
a storage configured to store at least one from among the token and the authentication template.

4. The user terminal of claim 1, wherein the registration information generator is further configured to generate a pair of public key and private key by performing authentication of the user using biometric information of the user and the registration information includes the public key.

5. The user terminal of claim 1, wherein the identification information comprises user identification information and user terminal identification information.

6. The user terminal of claim 5, wherein the token comprises a hash value for each of the user identification information and the user terminal identification information.

7. A non-face-to-face authentication service server comprising:
an initialization processor configured to:
receive a registration initialization message including identification information from a user terminal; and
transmit the registration initialization message to a biometric authentication server;
a token generator configured to generate a token using the identification information;
a message processor configured to:
receive a registration request message for requesting registration information from the biometric authentication server; and
transmit the registration request message and an authentication target data request message for requesting authentication target data for non-face-to-face authentication to the user terminal;
a data receiver configured to receive the authentication target data and a registration response message including the registration information from the user terminal;
a non-face-to-face authentication processor configured to:
decrypt the received authentication target data using the token;
provide the decrypted authentication target data to an authentication administrator that performs non-face-to-face authentication; and
receive a result of the non-face-to-face authentication from the authentication administrator;
a registration processor configured to:
transmit the registration response message to the biometric authentication server when the non-face-to-face authentication is successfully performed; and
receive a registration result of the registration information from the biometric authentication server; and
a result provider configured to transmit the non-face-to-face authentication result and the registration result of the registration information to the user terminal.

8. The non-face-to-face authentication service server of claim 7, wherein the registration request message and the registration response message each include a verification value generated at the biometric authentication server.

9. The non-face-to-face authentication service server of claim 7, wherein the identification information comprises user identification information and user terminal identification information of the user terminal.

10. The non-face-to-face authentication service server of claim 9, wherein the token comprises a hash value for each of the user identification information and the user terminal identification information.

11. The non-face-to-face authentication service server of claim 7, further comprising a storage configured to store at least one from among the token and the authentication target data.

12. A method of authentication performed by a user terminal, the method comprising:
generating a token by using identification information;
transmitting a registration initialization message including the identification information to a non-face-to-face authentication service server;
receiving an authentication target data request message for requesting authentication target data for non-face-to-face authentication;
receiving a registration request message for requesting registration information to be registered in a biometric authentication server that performs biometric information-based authentication from the non-face-to-face authentication service server;
receiving the authentication target data that is input by a user;
encrypting the authentication target data using the token;
generating the registration information by performing authentication of the user;
transmitting the encrypted authentication target data and a registration response message including the registration information to the non-face-to-face authentication service server; and
receiving a result of the non-face-to-face authentication and a registration result of the registration information from the non-face-to-face authentication service server.

13. The method of claim 12, wherein the registration request message and the registration response message each include a verification value generated at the biometric authentication server.

14. The method of claim 12, further comprising:
generating an authentication template by extracting a feature from the authentication target data; and
storing at least one from among the token and the authentication template.

15. The method of claim 12, wherein the generating of the registration information comprises generating a pair of public key and private key by performing authentication of the user using biometric information of the user and the registration information includes the public key.

16. The method of claim 12, wherein the identification information comprises user identification information and user terminal identification information.

17. The method of claim 16, wherein the token comprises a hash value for each of the user identification information and the user terminal identification information.

18. A method of authentication performed by a non-face-to-face authentication service server, the method comprising:
receiving a registration initialization message including identification information from a user terminal;
generating a token using the identification information;
transmitting the registration initialization message to a biometric authentication server;
receiving a registration request message for requesting registration information from the biometric authentication server;
transmitting the registration request message and an authentication target data request message for requesting authentication target data for non-face-to-face authentication to the user terminal;
receiving the authentication target data and a registration response message including the registration information from the user terminal;
decrypting the received authentication target data using the token and providing the decrypted authentication target data to an authentication administrator that performs non-face-to-face authentication;
receiving a result of the non-face-to-face authentication from the authentication administrator;
transmitting the registration response message to the biometric authentication server when the non-face-to-face authentication is successfully performed;
receiving a registration result of the registration information from the biometric authentication server; and
transmitting the non-face-to-face authentication result and the registration result of the registration information to the user terminal.

19. The method of claim 18, wherein the registration request message and the registration response message each include a verification value generated at the biometric authentication server.

20. The method of claim 18, wherein the identification information comprises user identification information and user terminal identification information of the user terminal.

21. The method of claim 20, wherein the token comprises a hash value for each of the user identification information and the user terminal identification information.

22. The method of claim 18, further comprising storing at least one from among the token and the authentication target data.
